(19) United States
(12) Patent Application Publication
(10) Pub. No.: US 2009/0102598 A1
(43) Pub. Date: Apr. 23, 2009

(54) SEMICONDUCTOR MEMORY DEVICE WITH VARIABLE RESISTANCE ELEMENT

(76) Inventors: Shinobu Yamazaki, Okayama (JP); Takuya Otabe, Hiroshima (JP)

Correspondence Address: NIXON & VANDERHYE, PC, 901 NORTH GLEBE ROAD, 11TH FLOOR, ARLINGTON, VA, 22203, US

(21) Appl. No.: 11/995,876

(22) PCT Filed: Jul. 5, 2006
(86) PCT No.: PCT/JP2006/313397

§ 371 Date: Jan. 16, 2008

(30) Foreign Application Priority Data
Jul. 20, 2005 (JP) 2005-209697

(51) Int. Cl. H01C 7/10

(52) U.S. Cl. 338/20

(57) ABSTRACT

A semiconductor memory device comprising a variable resistance element having a variable resistor between a first electrode and a second electrode, in which electric resistance is changed by applying a voltage pulse between the electrodes comprises at least one reaction preventing film made of a material having an action of blocking the permeation of a reduction species promoting a reduction reaction of the variable resistor and an oxidation species promoting an oxidation reaction of the variable resistor. This prevents the resistance value of the variable resistance element from fluctuating due to a reduction reaction or an oxidation reaction of the variable resistor caused by hydrogen or oxygen existing in the manufacturing steps, so that a semiconductor memory device having a small variation of the resistance value and having a good controllability can be realized with good repeatability.

### CROSS-REFERENCE TO RELATED APPLICATIONS

This application is a National Phase fling under 35 U.S.C. § 371 of International Application No. PCT/JP2006/313397 filed on Jul. 5, 2006, and which claims priority to Japanese Patent Application No. 2005-209697 filed on Jul. 20, 2005.

### TECHNICAL FIELD

The present invention relates to a semiconductor memory device comprising a variable resistance element having a variable resistor between a first electrode and a second electrode in which electric resistance is changed by applying a voltage pulse between the electrodes.

### BACKGROUND ART

In recent years, various device structures have been proposed such as FeRAM (Ferroelectric RAM), MRAM (Magnetic RAM), and OUM (Ovonic Unified Memory) as a next-generation nonvolatile random access memory (NVRAM) that is capable of high speed operation replacing a flash memory, and an intense competition of development is performed from the viewpoints of enhancement of performance, increase in reliability, achieving cost reduction, and process consistency. However, each of these present devices has advantages and disadvantages, and an ideal realization of “a universal memory” having the advantages of each of SRAM, DRAM, and flash memory still has been far away.

With respect to the existing techniques, a method of changing electric resistance reversibly by applying a voltage pulse to a perovskite material known for a colossal magnetoresistance effect is disclosed in Patent Documents 1 and 2 described below by Shangquing Liu, Alex Ignatiev et al. of Houston University in U.S.A. This is an extremely innovative method in which a change in the resistance appears over a few orders even at room temperature without an application of a magnetic field while using a perovskite material known for a colossal magnetoresistance effect. Because a resistive nonvolatile memory: RRAM (Resistance Random Access Memory) using a variable resistance element using this phenomenon does not require any magnetic field being different from MRAM, power consumption is extremely low, micro fabrication and high integration are also easy, and because dynamic range of the change of resistance is remarkably broader compared with MRAM, it has a characteristic that a multilevel storage is possible.

A basic structure of the actual variable resistance element is extremely simple, and it has a structure of which a lower electrode material, a variable resistor, and an upper electrode material are layered in this order in a direction perpendicular to a substrate. Moreover, in the element structure exemplified in Patent Document 1, the lower electrode material deposited on a single crystal substrate of a lanthanum-aluminum oxide LaAlO₃ (LAO) is formed with an yttrium-barium-copper oxide YBa₂Cu₃O₇ (YBCO) film, the variable resistor is formed with a crystalline proseodimium-calcium-manganese oxide Pr_{1-X}Ca_{X}MnO₃ (PCMO) film, that is a perovskite oxide, and the upper electrode material is formed with an Ag film deposited by sputtering respectively. It was reported that resistance could be reversibly changed by applying a voltage pulse of 51 volts positively and negatively between the upper electrode and the lower electrode as operation of this variable resistance element. By reading out the resistance value in this reversible resistance changing operation, a new resistive memory device is considered to be able to be realized.

Further, a ZnSe—Ge hetero structure and metal oxides of n, Nb, Hf, Zr, Ta, Ni, V, Zn, Sn, In, Th, Al, etc., as a material of the variable resistor other than the above-described perovskite material, are known to have a resistance value that is variable depending on the applied voltage pulse condition, although the variation may be small.

A schematic cross-sectional structure drawing of a resistive semiconductor memory device equipped with this variable resistance element as one conventional example is shown in FIG. 17.

A memory cell in this semiconductor memory device comprises a select transistor T formed on a semiconductor substrate 101 and a variable resistance element R. The select transistor T comprises a gate electrode 104, a gate insulation film 103, a drain region 105 and a source region 106 that are a diffusion layer, and is electrically separated from an adjacent memory cell with an element separation region 102. Further, the variable resistance element R is configured with a layered structure of a first electrode 112 that is an upper electrode, a variable resistor 111, and a second electrode 110 that is a lower electrode as described above.

The variable resistance element R is electrically connected with the drain region 105 of the select transistor T through a contact hole penetrating a first interlayer insulation film 107 formed on the select transistor T. Moreover, a barrier film 109 provided between the second electrode 110 and the first interlayer insulation film 107 has a purpose of securing a stable connection resistance between the variable resistance element R and a conductive contact plug embedded in the contact hole 108.

First metal wirings 116 and 117 to apply an electric signal to the variable resistance element R and the select transistor T are electrically connected to the source region 106 of the select transistor T and the first electrode 112 of the variable resistance element R through a contact hole 114 penetrating a second interlayer insulation film 113 and the first interlayer insulation film 107 and a contact hole 115 penetrating the second interlayer insulation film 113, respectively.

Further, as a multi-layer wiring process for speed acceleration and a high integration, the second metal wiring 119 is formed on a third interlayer insulation film 118, and a passivation film 120 as a surface protecting film is formed thereon.

Patent Document 1: U.S. Pat. No. 6,204,139
Non-Patent Document 1: Liu, S. Q. et al., “Electric-pulse-induced reversible resistance change effect in magnetoresistive films”, Applied Physics Letter, Vol. 76, pp. 2749-2751, 2000.

### DISCLOSURE OF THE INVENTION

### Problems to be Solved by the Invention

In the resistive semiconductor memory device equipped with the above-described variable resistance element R, a SiNx film or a SiOxNy film, etc. formed by a plasma CVD method (Plasma Activated Chemical Vapor Deposition) having moisture resistance against external moisture and a block action against external contamination is generally used as the passivation film 120 that is a surface protecting film. Because radical hydrogen atoms are generated when a film is formed in the plasma CVD method, a large amount of hydrogen atoms are contained in the film of the passivation film 120.

Further, a W film superior in embedding coating property is generally used as a material of the conductive contact plug embedded in the contact holes 114 and 115. The W film is generally formed in a thermal CVD method by a thermal reaction of WF₆ and SiH₄, and hydrogen is produced in the thermal reaction at the film formation.

Here, a group of the present inventors found that when a state in which a reduction reaction or an oxidation reaction occurs comes after the formation of the variable resistor, the variable resistor is affected by the reduction reaction or the oxidation reaction. For example, a phenomenon occurs in which the resistance value of the variable resistor changes by the reduction reaction when hydrogen is generated as described above. On the other hand, a phenomenon in which the resistance value of the variable resistance element changes also by the oxidation reaction against the variable resistor occurs similarly. Moreover, whether the resistance value increases or decreases depending on the reduction reaction or the oxidation reaction differs by the material used for the variable resistor.

In the above-described conventional semiconductor memory device, when the variable resistor undergoes a reduction reaction, the resistance value increases, and when it undergoes an oxidation reaction, the resistance value decreases. For example, when hydrogen is generated during the film formation by a plasma CVD method and the film forming of the W film etc. as described above, the resistance value of the variable resistor increases by the reduction reaction. Further, during the formation of a silicon oxide film generally used as the second interlayer insulation film 113 and the third interlayer insulation film 118, there is a small amount of oxygen unrelated to the film forming reaction, and an oxidation reaction promoted by the oxygen causes the resistance value of the variable resistor to decrease.

Furthermore, because amounts of hydrogen and oxygen generated on the semiconductor substrate is roughly proportional to the film thickness of the formed film, a problem in which the variation of the resistance value of the variable resistance element becomes large corresponding to the variation of the film thickness of the films formed within the surface of the semiconductor substrate, between semiconductor substrates, and between processes is caused.

In order to secure a stable operation as a semiconductor memory device, it is necessary to control the resistance value of the variable resistance element accurately. However, when the variable resistor is applied to the semiconductor memory device, because the resistance value of the variable resistance element fluctuates due to hydrogen that is a reduction species promoting the reduction reaction or oxygen that is an oxidation species promoting the oxidation existing in the manufacturing step as described above, variation becomes large, and it has been difficult to produce a semiconductor memory device equipped with variable resistance elements having the same resistance value with good repeatability and stability.

Further, because a small change of manufacturing process conditions such as a film thickness of the formed film causes a fluctuation in the resistance value of the variable resistance element, a limitation is given to the changes, and there is also a problem that it can be manufactured only with a limited manufacturing process.

Then, in view of the above-described problems, an object of the present invention is to provide a resistive semiconductor memory device that prevents a resistance change of the variable resistance element due to the process in the middle of the manufacturing step and that is equipped with a stable variable resistance element.

### Means for Solving the Problem

In order to achieve the above-described object, the semiconductor memory device of the present invention comprises a variable resistance element having a variable resistor between a first electrode and a second electrode, in which electric resistance between the first electrode and the second electrode is changed by applying a voltage pulse between the first electrode and the second electrode, and at least one layer of a reaction preventing film.

Further, the semiconductor memory device of the present invention is characterized in that the reaction preventing film prevents diffusion of a reduction species and suppresses reduction reaction of the variable resistor.

Further, the semiconductor memory device of the present invention is characterized in that the reaction preventing film prevents diffusion of an oxidation species and suppresses an oxidation reaction of the variable resistor.

Further, the semiconductor memory device of the present invention is characterized in that the reaction preventing film is arranged in close contact with the variable resistance element.

Further, the semiconductor memory device of the present invention is characterized in that the reaction preventing film is arranged between the variable resistance element and a surface protecting film.

Further, the semiconductor memory device of the present invention is characterized in that a conductive material filled in a contact hole formed on the first electrode or the second electrode contains a material having a function of suppressing diffusion of at least any one of the reduction species and the oxidation species.

Further, the semiconductor memory device of the present invention is characterized in that the conductive material filled in the contact hole is a conductive nitride containing at least one element selected from Si, Al, Ti, Ta, Hf, and W, a conductive oxide containing at least one element selected from Ir and Ru, a metal element selected from Ti, Ta, Ir, and Ru, or an alloy containing at least one element selected from Ti, Ta, Ir, Ru, and W.

Further, the semiconductor memory device of the present invention is characterized in that the reaction preventing film is an oxide containing at least one element selected from Al, Ti, Ta, Hf, Pb, La, Zr, Sr, Bi, Pr, Ca, Mn, Si, Mg, and Ce, a nitride containing at least one element selected from Si, Al, Ti, Ta, Hf, and W, a metal element selected from Ti, Ta, Ir, and Ru, or an alloy containing at least one element selected from Ti, Ta, Ir, Ru, and W.

Further, the semiconductor memory device of the present invention is characterized in that the variable resistor is an oxide having a perovskite structure containing at least one element selected from Pr, Ca, La, Sr, Gd, Nd, Bi, Ba, Y, Ce, Pb, Sm, and Dy and at least one element selected from Ta, Ti, Cu, Mn, Cr, Co, Fe, Ni, and Ga.

Further, the semiconductor memory device of the present invention is characterized in that the variable resistor is an oxide having a perovskite structure represented by any one of the following formulas (0≦X≦1, 0≦Z<1): Pr₁₋ₓCaₓ[Mn_{1-z}M_{z}]O₃ (where M is any element selected from Ta, Ti, Cu, Cr, Co, Fe, Ni, and Ga); La₁₋ₓAEₓMnO₃ (where AE is any divalent alkaline earth metal selected from Ca, Sr, Pb, and Ba); RE₁₋ₓSrₓMnO₃ (where RE is any trivalent rare earth metal selected from Sm, La, Pr, Nd, Gd, and Dy); La₁₋ₓCoₓ[Mn_{1-z}Co_{z}]O₃; Gd₁₋ₓCaₓMnO₃; and Nd₁₋ₓGdₓMnO₃.

Further, the semiconductor memory device of the present invention is characterized in that the variable resistor is a ZnSe—Ge hetero structure or a metal oxide containing at least one element selected from Ti, Nb, Hf, Zr, Ta, Ni, A, Zn, Sn, In, Th, and Al.

Further, the semiconductor memory device of the present invention comprising a variable resistance element having a variable resistor between a first electrode and a second electrode in which the electric resistance between the first electrode and the second electrode is changed by applying a voltage pulse between the first electrode and the second electrode, is characterized in that a conductive material filled in a contact hole formed on the first electrode or the second electrode contains a material having a function of suppressing diffusion of a reduction species or an oxidation species.

The conductive material filled in the contact hole is characterized by being a conductive nitride containing at least one element selected from Si, Al, Ti, Ta, Hf, and W, a conductive oxide containing at least one element selected from Ir and Ru, a metal element selected from Ti, Ta, Ir, and Ru, or an alloy containing at least one element selected from Ti, Ta, Ir, Ru, and W.

### EFFECT OF THE INVENTION

The semiconductor memory device equipped with a variable resistance element of the present invention is configured to have at least one layer of a reaction preventing film. Because this reaction preventing film is made of a material having an action to block permeation of a reduction species promoting a reduction reaction of the variable resistor and an oxidation species promoting an oxidation reaction of the variable resistor, an increase in fluctuation of the resistance value due to the reduction reaction of the variable resistor or a decrease in fluctuation of the resistance value due to the oxidation reaction of the variable resistor are suppressed. Further, especially by arranging the reaction preventing film between the variable resistance element and the passivation, it becomes possible to prevent an influence of the process in the middle of the manufacturing step on and after the film formation of the variable resistor.

Therefore, according to the semiconductor memory device equipped with a variable resistance element of the present invention, a semiconductor memory device having a small variation of the resistance value and having a good controllability can be realized with good repeatability.

### BRIEF DESCRIPTION OF THE DRAWINGS

FIG. 1 is a schematic cross-sectional view of the semiconductor memory device equipped with a variable resistance element according to the present invention.

FIG. 2 is a schematic cross-sectional view in which the manufacturing method of the semiconductor memory device according to the present invention is described in order of steps.

FIG. 3 is a schematic cross-sectional view in which the manufacturing method of the semiconductor memory device according to the present invention is described in order of steps.

FIG. 4 is a schematic cross-sectional view in which the manufacturing method of the semiconductor memory device according to the present invention is described in order of steps.

FIG. 5 is a schematic cross-sectional view in which the manufacturing method of the semiconductor memory device according to the present invention is described in order of steps.

FIG. 6 is a schematic cross-sectional view in which the manufacturing method of the semiconductor memory device according to the present invention is described in order of steps.

FIG. 7 is a schematic cross-sectional view in which the manufacturing method of the semiconductor memory device according to the present invention is described in order of steps.

FIG. 8 is a schematic cross-sectional view in which the manufacturing method of the semiconductor memory device according to the present invention is described in order of steps.

FIG. 9 is a drawing showing a resistance measurement result of the variable resistance element in the conventional semiconductor memory device.

FIG. 10 is a drawing showing a resistance measurement result of the variable resistance element in the semiconductor memory device according to the present invention.

FIG. 11 is a schematic cross-sectional view showing a modified example 1 of the semiconductor memory device equipped with a variable resistance element according to the present invention.

FIG. 12 is a schematic cross-sectional view showing a modified example 2 of the semiconductor memory device equipped with a variable resistance element according to the present invention.

FIG. 13 is a schematic cross-sectional view showing a modified example 3 of the semiconductor memory device equipped with a variable resistance element according to the present invention.

FIG. 14 is a schematic cross-sectional view showing a modified example 4 of the semiconductor memory device equipped with a variable resistance element according to the present invention.

FIG. 15 is a schematic cross-sectional view showing a modified example 5 of the semiconductor memory device equipped with a variable resistance element according to the present invention.

FIG. 16 is a schematic cross-sectional view showing a modified example 6 of the semiconductor memory device equipped with a variable resistance element according to the present invention.

FIG. 17 is a schematic cross-sectional view of the conventional semiconductor memory device equipped with a variable resistance element.

### EXPLANATION OF THE REFERENCE NUMERALS

T Select transistor
R Variable resistive element
101 Semiconductor substrate
102 Element separation region
103 Gate insulation film
104 Gate electrode
105 Drain region
106 Source region
107 First interlayer insulation film
108, 114, 115 Contact hole
109 Barrier layer
110 Lower electrode
111 Variable resistor
112 Upper electrode
113 Second interlayer insulation film
116, 117 First wiring layer
118 Third interlayer insulation film
119 Second wiring layer
120 Passivation film
201, 202, 203, 204, 205, 206, 207 Reaction preventing film

### BEST MODE FOR CARRYING OUT THE INVENTION

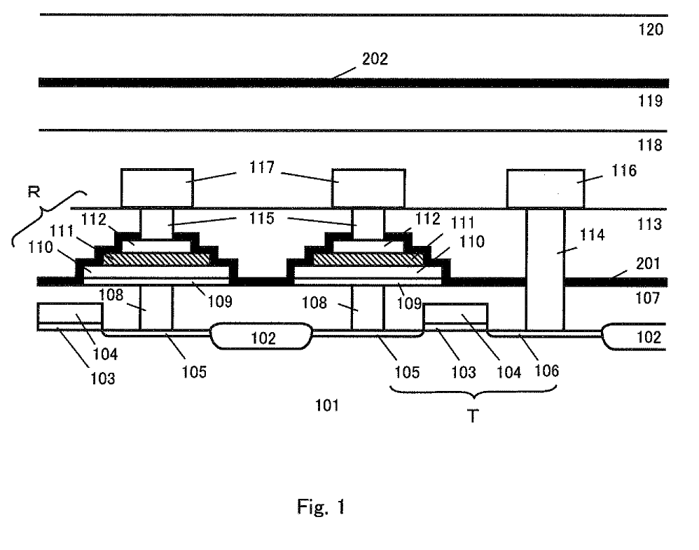

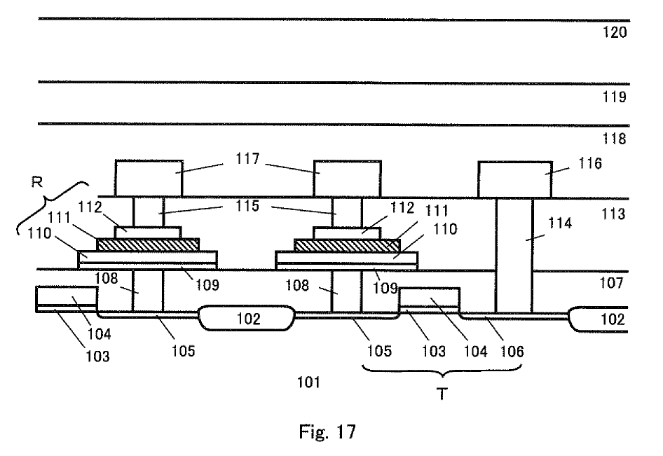

Hereinafter, embodiments of the semiconductor memory device according to the present invention is explained with reference to figures. A schematic cross-sectional drawing of the resistive semiconductor memory device equipped with a variable resistance element of the present invention is shown in FIG. 1. In the semiconductor memory device of the embodiment of the present invention, the reaction preventing films 201 and 202 are added to the conventional resistive semiconductor memory device shown in FIG. 17. That is, the reaction preventing film 201 is arranged on the variable resistance element R and the reaction preventing film 202 is arranged directly under the passivation film 120. The reaction preventing film 201 prevents an invasion of hydrogen that is a reduction species or oxygen that is an oxidation species into the variable resistance element R, and the reaction preventing film 202 has a function of preventing diffusion of hydrogen that is a reduction species from the passivation film 120. Moreover, for the same configuration as the resistive semiconductor memory device shown in FIG. 17, the same reference numerals are provided, and the explanation is omitted.

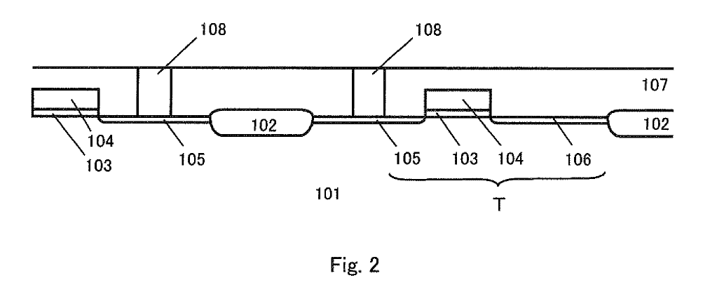

FIGS. 2 to 8 are schematic cross-sectional configuration drawings in which the manufacturing steps of the semiconductor memory device are shown in order of the step flow. The semiconductor memory device having the structure in the present embodiment can be formed through the steps explained in detail with reference to the figures below.

First, as shown in FIG. 2, the select transistor T is formed on the semiconductor substrate 101 according to a known procedure. That is, the select transistor T comprising the gate insulation film 103, the gate electrode 104, and the drain region 105 and the source region 106 that are a diffusion layer is formed on the semiconductor substrate 101 in which the element separation region 102 is formed. After that, the first interlayer insulation film 107 is formed thereon. In the present example, a BPSG (borophosphosilicate glass) film is deposited with a film thickness of 1200 nm, and then the surface of the film is polished and flattened with a so-called CMP method (a Chemical Mechanical Polishing method) until the thickness of the BPSG film on the gate electrode 104 becomes 400 nm.

Next, by etching the first interlayer insulation film 107 using a resist patterned with a known photolithography method as a mask, the contact hole 108 reaching the drain region 105 of the select transistor T is opened. Then, after a conductive polysilicon film is deposited, the conductive polysilicon film on the first inter-layer insulation film 107 is completely removed by polishing with a COMP method, and the conductive polysilicon film remains only in the contact hole 108. With this step, a contact plug in which the conductive polysilicon film is filled only in the contact hole 108 is formed.

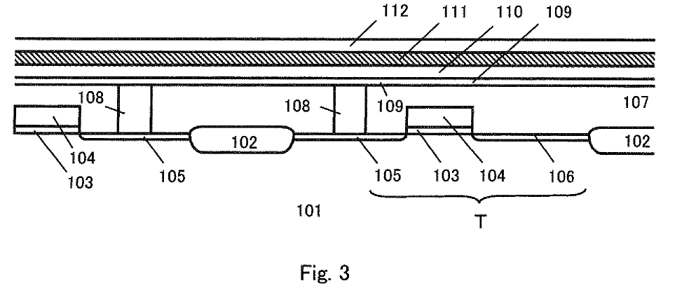

Next, as shown in FIG. 3, a barrier metal layer 109 for securing an electrical connection of the conductive contact plug embedded in the contact hole 108 with the lower electrode 110, a film 110 that becomes a material of the lower electrode, a film 111 that becomes a material of the variable resistor, and a film 112 that becomes a material of the upper electrode are formed one by one.

In the present invention, the barrier metal layer 109 is made to have a layered structure (TiN/Ti film) in which each of a Ti film of 20 nm thickness and a TiN film of 50 nm thickness are layered one by one with a sputtering method.

Further, in the present example, the Pt film 110 as one example of the second electrode that is the lower electrode is deposited at a film thickness of 100 to 200 nm.

Further, in the present example, the PCMO film 111 as one example of the variable resistor is formed at a film thickness of 100 nm with a sputtering method. The formation of the PCMO film 111 is performed by heating a substrate to 300° C. to 500° C., sputtering a target of a PCMO sintered body with Ar ions at a film forming pressure of 5 to 20 mTorr, and reacting it with oxygen introduced as a reactive gas, and forming a film on the substrate. In the present example, a PCMO film is formed with a composition ratio of Pr_{0.7}Ca_{0.3}MnO₃.

Further, in the present example, the Pt film 112 as one example of the first electrode that is the upper electrode is deposited at a film thickness of 100 nm with a sputtering method.

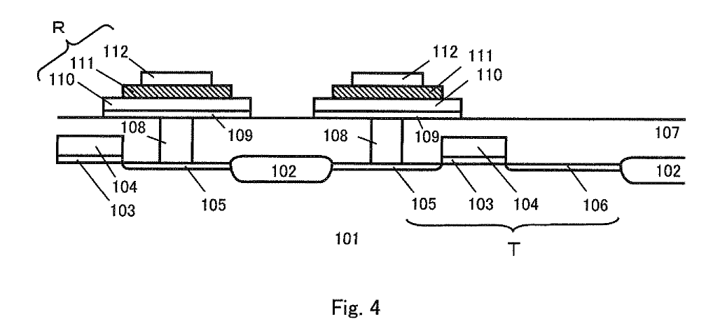

Next, as shown in FIG. 4, the variable resistance element R is formed. That is, the upper electrode 112 is formed by dry etching the Pt film 112 that is a material of the first electrode using a resist patterned with a photolithography method as a mask, and by etching the resistive film 111, the lower electrode 110, and the barrier metal film 109 one by one by the same procedure.

Next, a thermal process is performed at a substrate heating temperature of 400° C. in a nitrogen atmosphere containing 1% of hydrogen gas for 15 minutes with a rapid thermal annealing (RTA) method. The purpose of this step is to increase the resistance value of the variable resistance element to a prescribed value.

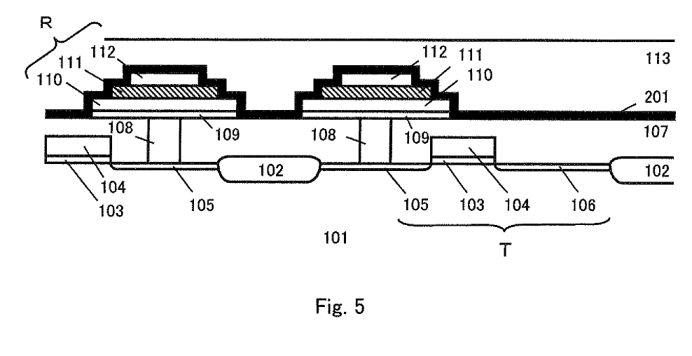

Next, the reaction preventing film 201 is formed on the variable resistance element R. In the present example, an AlOx film is formed at a thickness of 50 nm using a sputtering method. Then, as shown in FIG. 5, a silicon oxide film of 1000 nm thickness is further formed on the reaction preventing film 201 as the second interlayer insulation film 113 with a CVD method, and then the surface is polished for flattening with a CMP method until the thickness of the silicon oxide on the upper electrode 112 becomes 400 nm.

Next, by etching the second interlayer insulation film 113 using a resist patterned with a photolithography method as a mask, the contact hole 115 reaching the upper electrode 112 is opened. Further, by etching the second interlayer insulation film 113, the reaction preventing film 201, and the first interlayer insulation film 107 one by one using a resist patterned with the same photolithography method as a mask, the contact hole 114 reaching the source region 106 of the select transistor T is opened. Then, after a W/TiN/Ti film is deposited, the W/TiN/Ti film on the second interlayer insulation film 107 is completely removed by polishing with a CMP method, and the W/TiN/Ti film remains only in the contact holes 114 and 115. With this step, a conductive contact plug made of a conductive material is formed only in the contact holes 114 and 115. Moreover, in the present example, a TiN/Ti film of 50 nm/20 nm thickness is formed with a sputtering method, and a W film of 600 nm thickness is formed with a CVD method thereon.

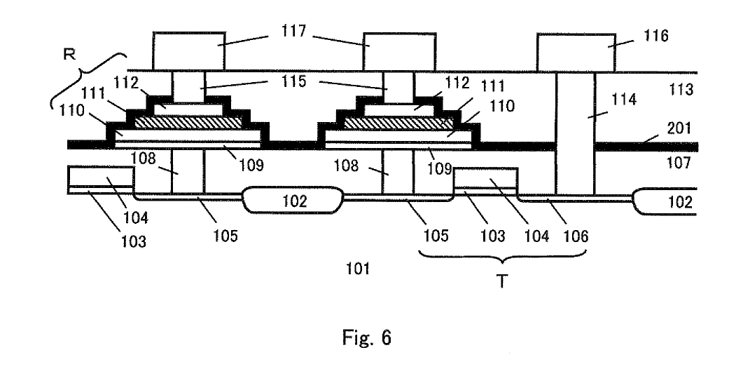

Next, a material film of the first metal wirings 116 and 117 is deposited. In the present example, a layered structure (a EN/Al—Si/TiN film) is made in which each of a TiN film of 50 nm thickness, an Al—Si film of 400 nm thickness, and a TiN film of 50 nm thickness are respectively deposited one by one with a sputtering method. Then, by etching the metal wiring material using a resist patterned with a photography method as a mask, as shown in FIG. 6, the first metal wirings 116 and 117 are formed.

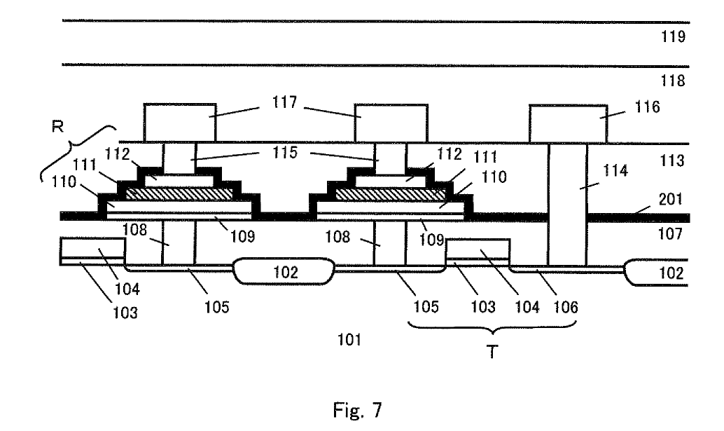

Next, the third interlayer insulation film 118 is formed on the first metal wirings 116 and 117. In the present example, a silicon oxide film of 1300 nm thickness is deposited with a plasma CV) method, and then the surface is further polished for flattening with a CMP method until the thickness of the silicon oxide film on the first metal wirings 116 and 117 becomes 500 nm. Then, after forming a contact hole (not shown in the figures) reaching the first metal wirings, as shown in FIG. 7, the material film 119 of the second metal wiring is deposited, and its process (not shown in the figures) is performed.

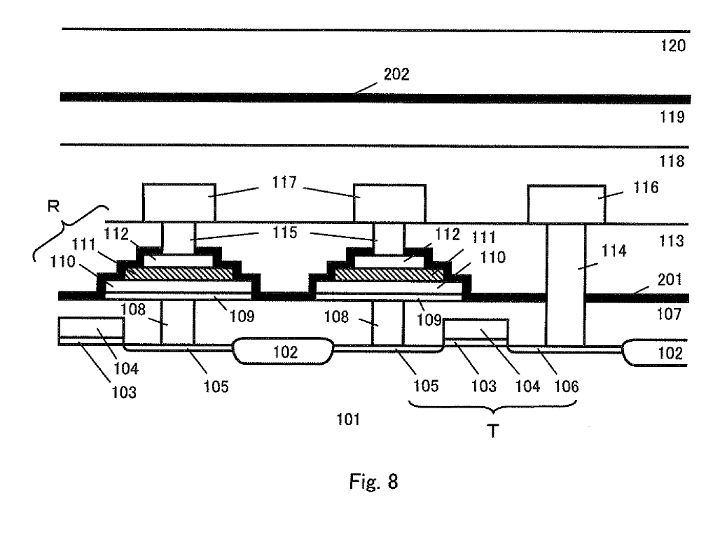

Next, the reaction preventing film 202 is formed on the second metal wiring 119. In the present example, an AlOx film is formed at a thickness of 50 nm using a sputtering method. Then, as shown in FIG. 8, the passivation film 120 as a surface protecting film is deposited. In the present example, a SiNx film of 1500 nm thickness is deposited with a plasma CVD method.

In addition, the above explanation is described by omitting general steps such as steps of applying, exposing, and developing a photoresist, a step of removing the photoresist after etching, and a cleaning step after etching and removing resist.

In the semiconductor memory device that is the embodiment of the present invention explained above, because the AlOx film formed as the reaction preventing film 201 has an action of blocking the permeation of hydrogen and oxygen, it has a function of preventing invasion of hydrogen that is a reduction species promoting the reduction reaction and oxygen that is an oxidation species promoting the oxidation reaction into the variable resistance element R, especially the variable resistor 111.

Further, because the AlOx film formed as the reaction preventing film 202 has an action of blocking the permeation of hydrogen and oxygen, it has a function of suppressing diffusion of hydrogen generated at the film formation of the passivation film 120 into the variable resistance element R.

Therefore, because an invasion of oxygen and hydrogen generated in the manufacturing steps into the variable resistance element R can be suppressed by the reaction preventing films 201 and 202, the reduction reaction and the oxidation reaction of the variable resistor 111 can be avoided.

Here, when an interlayer insulation film such as a silicon oxide film exists between the reaction preventing film 201 and the variable resistance element R, the variable resistance element R is affected by oxygen or hydrogen in the interlayer insulation film, and therefore the reaction preventing film 201 is more desirably arranged in close contact with the variable resistance element R.

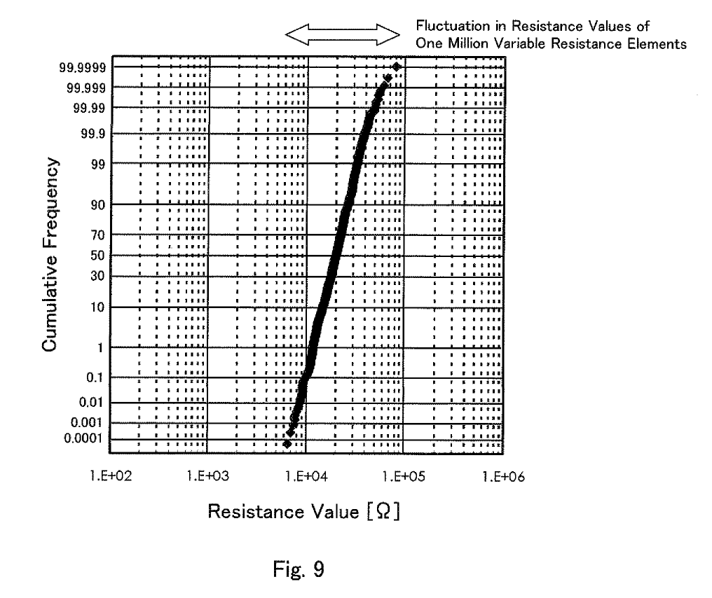

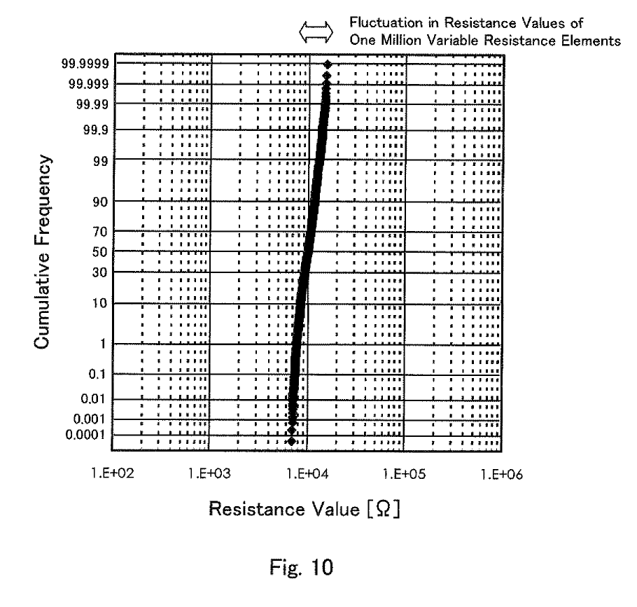

Next, superiority of the semiconductor memory device of the present invention is explained below with reference to electrical characteristics data. FIG. 9 is the distribution of the resistance values of 1,000,000 variable resistance elements in a low resistance state in the semiconductor memory device in which the reaction preventing films 201 and 202 are not formed, and similarly, FIG. 10 is the distribution of the resistance values of 1,000,000 variable resistance elements in a low resistance state in the semiconductor memory device of the present invention. The horizontal axis shows the resistance value of the variable resistance element, and the vertical axis shows the cumulative frequency of the variable resistance element in a normal distribution scale. As shown in FIG. 9, there is a fluctuation of the resistance value of one order or more in the conventional semiconductor memory device. However, as shown in FIG. 10, the fluctuation of the resistance value is suppressed to about one third in the semiconductor memory device of the present invention. The improvement of this fluctuation is an effect in which the reaction preventing films 201 and 202 are structurally given, and is because the reaction preventing films 201 and 202 prevent diffusion of oxygen and hydrogen generated in the manufacturing steps into the variable resistor, and an increase in fluctuation of the resistance value by the reduction reaction of the variable resistor and an decrease in fluctuation of the resistance value by the oxidation reaction of the variable resistor are suppressed. As a result, in a memory device in which multilevel information is stored by setting different resistance values to one variable resistor, a level judgment of the stored information becomes easy, and a memory device with high reliability can be configured.

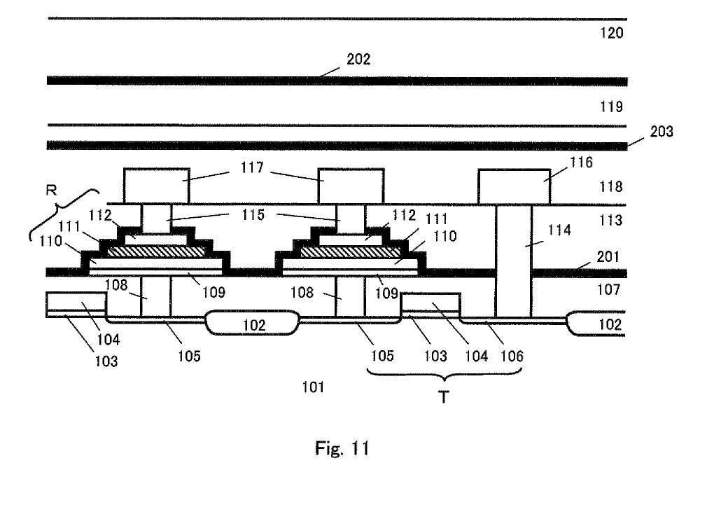

The semiconductor memory device of the present invention is not limited to the structure of the example explained above. As modified examples 1 to 6 shown in FIGS. 11 to 16, an application of the reaction preventing film that is a characteristic of the present invention can be appropriately changed. The modified examples are explained in detail with reference to the present figures hereinafter.

In the example shown in FIG. 1, a structure having two reaction preventing films 201 and 202 is made. However, the number of the reaction preventing films is not limited to this. For example, as shown in the modified example 1 of the present embodiment shown in FIG. 11, three reaction preventing films may be used. That is, to the example shown in FIG. 1, the reaction preventing film 203 may be further arranged in the third interlayer insulation film 118. In this case, because the three reaction preventing films 201, 202 and 203 become a protection film especially at the formation of the passivation film 120 and the film thickness per one layer can be thinner compared with the example in FIG. 1 (in the case of two layers), there is an advantage that a process to which the reaction preventing film is related (for example, etching of the contact holes 114 and 115) can be performed easily. Further, because a material having a somewhat weak prevention ability of each layer can be used, there is an advantage that the selection of the material of the reaction preventing film becomes wider.

Further, contrary to this, only one layer of the reaction preventing film may also be used as long as it is between the variable resistance element R and the passivation film. In this case, in order to suppress the reduction and the oxidation reactions of the variable resistor as in the reaction preventing film 201 in FIGS. 1 and 11, it is more desirably arranged in close contact with the variable resistance element R. However, in this case, the film thickness, material, etc. that are necessary to exhibit the same effect as the example in FIG. 1 (in the case of two layers) are required for the reaction preventing film 201.

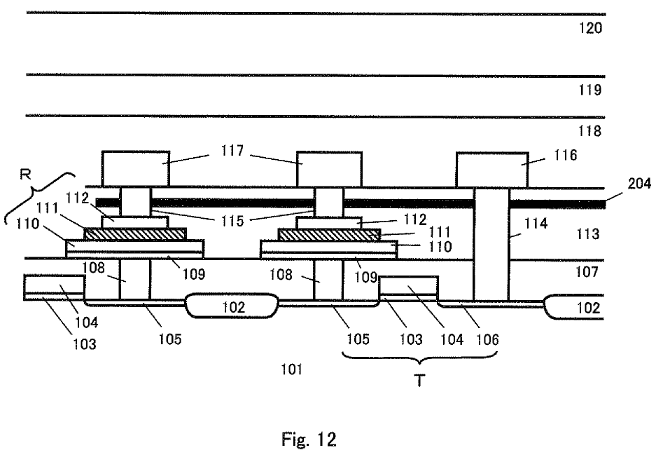

In the case of arranging the reaction preventing film 201 in close contact with the variable resistance element R, because steps exist due to the process of the first electrode 112, the variable resistor 111, and the second electrode 110, a good coating property is required for the film formation of the reaction preventing film 201 so that the thickness of the formed film does not become extremely thin on the side face of the variable resistance element R. Contrary to this, in the modified example 2 of the present embodiment shown in FIG. 12, because the reaction preventing film 204 is arranged in the second interlayer insulation film 113 and the reaction preventing film 204 is formed on the surface where the difference between each step of the variable resistance element R is reduced, a film in which the coating property is inferior can be applied. In this case, the variable resistance element R is affected although it is slightly, by a part of the interlayer insulation film 113 existing between the reaction preventing film 204 and the variable resistance element R. However, the present structure can be selected considering this effect and a decrease of the reaction preventing ability due to the above-described problem of the coating property.

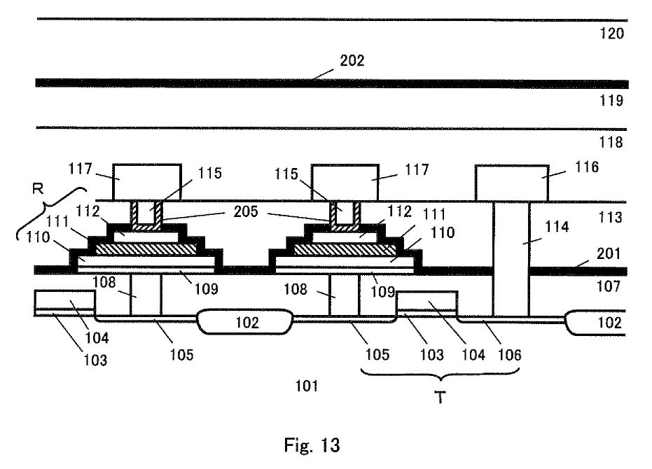

Further, in the example shown in FIG. 1, a W/TiN/Ti film is used as a material of a conductive contact plug embedded in the contact hole 115. Here, because the TiN film has an action of blocking the permeation of oxygen and hydrogen, even though the opening part 115 is on the reaction preventing film 201, as a result the contact plug has been playing a role of cutting off the oxygen and the hydrogen. Then, as in the modified example 3 of the present embodiment shown in FIG. 13, the reaction element film 205 made of TiN may be arranged in the contact hole 115. In this case, a limitation is not given to the selection of the material embedded in the contact hole 115. However the reaction preventing film 205 has to be a conductive material.

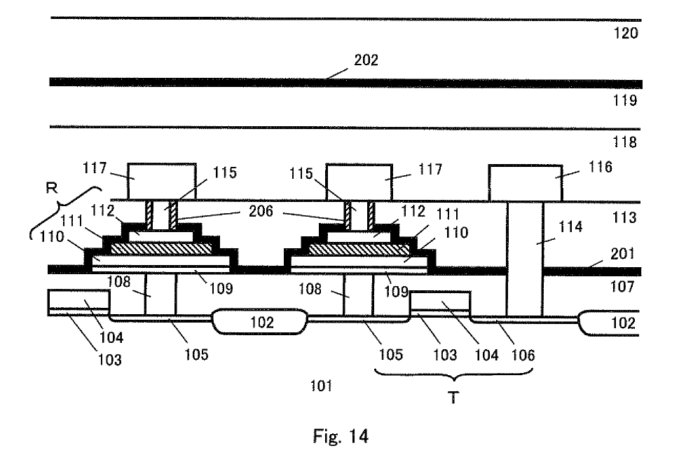

Further, as in modified example 4 of the present embodiment shown in FIG. 14, the reaction preventing film 206 may be arranged only on the side face inside the contact hole 115. In this case, the reaction preventing film 206 is not necessarily a conductive material and may be an insulation material such as AlOx.

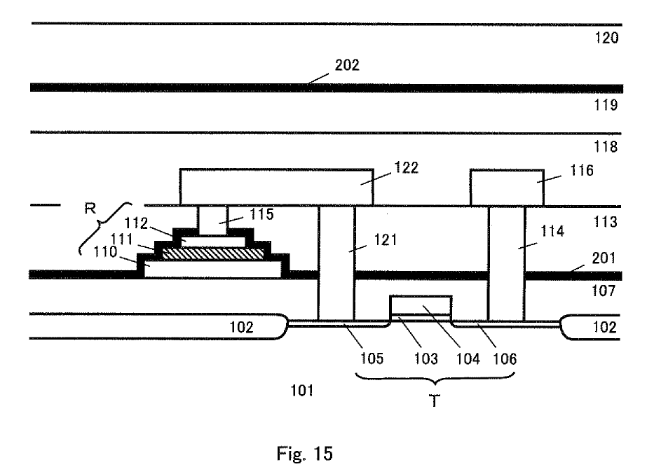

The examples and the modified examples of FIGS. 1 to 8 and FIGS. 11 to 14 explained above is made to have a structure in which the second electrode 110 that is the lower electrode and the drain region 105 of the select transistor T are connected through a conductive contact plug. However, it is not limited to this. For example, as in the modified example 5 of the present embodiment shown in FIG. 15, the reaction preventing films 201 and 202 may be similarly applied to a memory cell having a configuration in which the first electrode 112 that is the upper electrode and the drain region 105 of the select transistor T are suspended from the metal wiring 122 to be connected to each other.

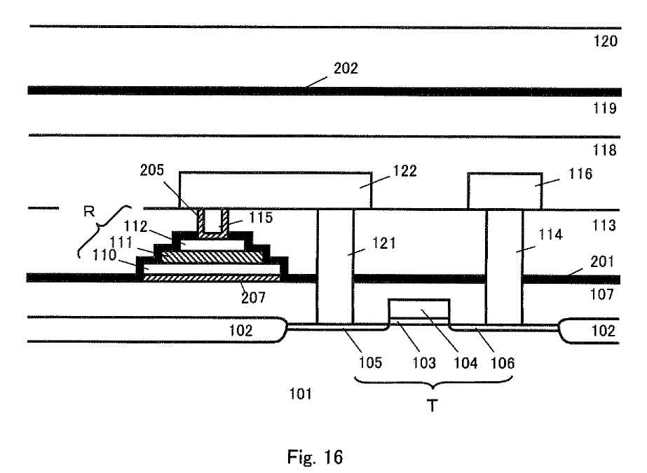

In the modified example 5 of FIG. 15, a Pt film is used as one example of the second electrode as in the example of FIG. 1. Here, the Pt film cannot prevent the permeation of oxygen and hydrogen. Then, as in the modified example 6 of the present embodiment shown in FIG. 16, the reaction preventing film 207 may be arranged under the second electrode that is the lower electrode. The material of the reaction preventing film 207 may be an insulation material such as AlOx and may be a conductive material containing a TiN film etc. Further, as in the modified example 3 of FIG. 13, by arranging the reaction preventing film 205 in the contact hole 115, the variable resistance element R may be completely enclosed by the reaction preventing films (in this case, 201, 205, and 207).

In the examples and the modified examples of FIGS. 1 to 8 and FIGS. 11 to 16 explained above, the variable resistance element R is made to have a structure in which the first electrode, the variable resistor, and the second electrode are processed one by one. However, it is not limited to this, and the configurations of the inventive points of the present invention are not lost even if the form of the variable resistance element has any structure as long as the reaction preventing film is arranged for the purpose of protecting the variable resistance element. Further, in the same manner, the memory cell configuration was made to be a memory cell configuration having the select transistor T. However, it is not limited to this. For example, the reaction preventing film may be applied in the same manner to a memory cell having a memory cell configuration in which the first electrode and the second electrode are directly selected and the data of the variable resistor at its cross point are directly read out, that is, a so-called cross point configuration.

In the examples and the modified examples 1 to 6, an aluminum oxide film (AlOx film) or a titanium nitride film (TiN film) is used as the reaction preventing films 201 to 207. However, they are not limited to this. For example, oxides and oxynitrides such as titanium oxide, tantalum oxide, zirconium oxide, strontium oxide, magnesium oxide, selenium oxide, lanthanum oxide, titanium aluminum oxide, tantalum aluminum oxide, titanium silicide oxide, tantalum silicide oxide, and titanium oxynitride are known as insulating materials having an action of blocking the permeation of the oxygen and hydrogen that can be applied to the reaction preventing films 201 to 205 and 207. Further, perovskite oxides such as strontium bismuth tantalite (SBT), barium strontium titanate (BST), lead zirconium titanate (PZT), lead titanate (PTO), strontium titanate (STO), and bismuth titanate (BIT) have the same function. Further, a silicon nitride film (SiNx film) and a silicon oxynitride film (SiOxNy film) also have good blocking property of the oxygen and the hydrogen, and can be applied as the reaction preventing film by forming the film with a LPCVD method (Low Pressure Chemical Vapor Deposition) in which hydrogen is hardly generated compared with a plasma CVD method. However, because the film forming temperature is high being around 700° C., it must be applied to the reaction preventing films 201, 204, 206, and 207 that are formed before the formation of the metal wirings 116 and 117.

Further, metals such as titanium, tantalum, iridium, ruthenium, etc., alloys such as titanium aluminum, tantalum aluminum, ruthenium silicide, tungsten boride, titanium boride, tungsten carbide, titanium carbide, etc., conductive nitrides such as titanium nitride, tantalum nitride, aluminum nitride, tungsten nitride, titanium aluminum nitride, tantalum aluminum nitride, titanium silicide nitride, tantalum silicide nitride, tungsten silicide nitride, iridium silicide nitride, platinum silicide nitride, etc., or conductive oxides such as iridium oxide, ruthenium oxide, strontium ruthenate (SRO), etc. are known as conductive materials that can be applied to the reaction preventing films 205 to 207 and have an action of blocking the permeation of oxygen and hydrogen.

Further, perovskite oxides shown as ABO₃ in a chemical formula and represented by lead titanate (PbTiO₃), barium titanate (BaTiO₃), etc. are used as the variable resistor 111. For example, a perovskite oxide including Pr and Mn is expressed such that Pr is substituted partially or entirely in a “A” position and Mn is substituted partially or entirely in a “B” position in the above-described chemical formula ABO₃, it can become a simple formula such as Pr_{1-X}A_{X}MnO₃ (0≦X≦1), for example, and it can become a formula in which the number of atoms substituted for A or B increases such as a (Pr_{1-X}A_{X})(Mn_{1-Z}B_{Z})O₃ (0≦X≦1, 0≦Z<1). At least one element selected from Ca, La, Sr, Gd, Nd, Bi, and Ce can be used in A. At least one element selected from Ta, Ti, Cu, Cr, Co, Fe, Ni, and Ga can be used in B.

Typical examples of the oxide having a perovskite structure that become the variable resistor 111 include (Pr, Ca)MnO₃, SrTiO₃, (Ba, Sr)TiO₃, LaMnO₃, LaTiO₃, (Nd, Sr)MnO₃, and (La, Sr)MnO₃.

The materials of this type present a phenomenon in which the electric resistance changes due to an application of a voltage pulse. However, among these, the Pr_{1-X}Ca_{X}MnO₃ type material (PCMO film) shows a larger change in the electric resistance value due to an application of a voltage pulse, and further, a composition near X=0.3 is preferable as the variable resistor 111 in the present invention.

Further, although the change in the electric resistance is smaller than the perovskite structure, a ZnSe—Ge hetero structure or metal oxides of Ti, Nb, Hf, Zr, Ta, Ni, A, Zn, Sn, In, Th, Al, etc. can be used as the variable resistor 111. In addition, when the resistance value of the variable resistor is changed by the oxidation reaction or the reduction reaction, the present invention can be applied even if any material is used as the variable resistor.

1. A semiconductor memory device comprising:
a variable resistance element having a variable resistor between a first electrode and a second electrode, in which electric resistance between the first electrode and the second electrode is changed by applying a voltage pulse between the first electrode and the second electrode; and
at least one layer of a reaction preventing film.

2. The semiconductor memory device according to claim 1, wherein
the reaction preventing film prevents diffusion of a reduction species and suppresses reduction reaction of the variable resistor.

3. The semiconductor memory device according to claim 1, wherein
the reaction preventing film prevents diffusion of an oxidation species and suppresses an oxidation reaction of the variable resistor.

4. The semiconductor memory device according to claim 1, wherein the reaction preventing film is arranged in close contact with the variable resistance element.

5. The semiconductor memory device according to claim 1, wherein the reaction preventing film is arranged between the variable resistance element and a surface protecting film.

6. The semiconductor memory device according to claim 1, wherein a conductive material filled in a contact hole formed on the first electrode or the second electrode contains a material having a function of suppressing diffusion of at least any one of the reduction species and the oxidation species.

7. The semiconductor memory device according to claim 6, wherein
the conductive material filled in the contact hole is a conductive nitride containing at least one element selected from Si, Al, Ti, Ta, Hf, and W, a conductive oxide containing at least one element selected from Ir and Ru, a metal element selected from Ti, Ta, Ir, and Ru, or an alloy containing at least one element selected from Ti, Ta, Ir, Ru, and W.

8. The semiconductor memory device according to claim 1, wherein
the reaction preventing film is an oxide containing at least one element selected from Al, Ti, Ta, Hf, Pb, La, Zr, Sr, Bi, Pr, Ca, Mn, Si, Mg, and Ce, a nitride containing at least one element selected from Si, Al, Ti, Ta, Hf, and W, a metal element selected from Ti, Ta, Ir, and Ru, or an alloy containing at least one element selected from Ti, Ta, Ir, Ru, and W.

9. The semiconductor memory device according to claim 1, wherein
the variable resistor is an oxide having a perovskite structure containing at least one element selected from Pr, Ca, La, Sr, Gd, Nd, Bi, Ba, A, Ce, Pb, Sm, and Dy and at least one element selected from Ta, Tin, Cu, Mn, Cr, Co, Fe, Ni, and Ga.

10. The semiconductor memory device according to claim 1, wherein
the variable resistor is an oxide having a perovskite structure represented by any one of the following formulas (0≦X≦1, 0≦Z<1):
Pr₁₋ₓCaₓ[Mn_{1-z}M_{z}]O₃ (where M is any element selected from Ta, Ti, Cu, Cr, Co, Fe, Ni, and Ga);
La₁₋ₓAEₓMnO₃ (where AE is any divalent alkaline earth metal selected from Ca, Sr, Pb, and Ba);
RE₁₋ₓSrₓMnO₃ (where RE is any trivalent rare earth metal selected from Sm, La, Pr, Nd, Gd, and Dy);
La₁₋ₓCoₓ[Mn_{1-z}Co_{z}]O₃;
Gd₁₋ₓCaₓMnO₃; and
Nd₁₋ₓGdₓMnO₃.

11. The semiconductor memory device according to claim 1, wherein
the variable resistor is a ZnSe—Ge hetero structure or a metal oxide containing at least one element selected from Ti, Nb, Hf, Zr, Ta, Ni, V, Zn, Sn, In, Th, and Al.

12. A semiconductor memory device comprising
a variable resistance element having a variable resistor between a first electrode and a second electrode in which electric resistance between the first electrode and the second electrode is changed by applying a voltage pulse between the first electrode and the second electrode, wherein
a conductive material filled in a contact hole formed on the first electrode or the second electrode contains a material having a function of suppressing diffusion of at least one of a reduction species and an oxidation species.

13. The semiconductor memory device according to claim 12, wherein
the conductive material filled in the contact hole is a conductive nitride containing at least one element selected from Si, Al, Ti, Ta, Hf and W, a conductive oxide containing at least one element selected from Ir and Ru, a metal element selected from Ti, Ta, Ir, and Ru, or an alloy containing at least one element selected from Ti, Ta, Ir, Ru, and W.
